(19) United States
(12) Patent Application Publication
(10) Pub. No.: US 2005/0126390 A1
(43) Pub. Date: Jun. 16, 2005

(54) Diaphragm article with fiber reinforcement and method of manufacturing same

(76) Inventors: Robert Fortin, South Berwick, ME (US); Jeffrey Bissonnette, Somersworth, NH (US); Derek Sargant, Barrington, NH (US)

Correspondence Address: RANDALL J. KNUTH P.C., 4921 DESOTO DRIVE, FORT WAYNE, IN, 46815, US

(21) Appl. No.: 10/980,535

(22) Filed: Nov. 3, 2004

Related U.S. Application Data
(60) Provisional application No. 60/516,984, filed on Nov. 3, 2003.

(51) Int. Cl. F16J 3/00

(52) U.S. Cl. 92/103 F

(57) ABSTRACT

A diaphragm article includes an elastomer body reinforced with a pulp dispersion of polyaramid fibers. The elastomer has a material composition consisting of a silicon and/or fluoro-silicon polymer. The elastomer is blended with fiber to produce a heterogenous mixture. A compression molding process is used to fabricate the diaphragm, where a composition of aramid reinforced elastomer is employed as the preform structure. The diaphragm structure provides an increased strength and stiffness threshold. One diaphragm form includes fibers oriented generally orthogonally to the central pressure axis to provide improved radial stiffness. The diaphragm construction may be augmented with fabric reinforcement to provide further improvements in durability and performance.

### CROSS-REFERENCE TO RELATED APPLICATIONS

This application claims the benefit of prior filed U.S. Provisional Application No. 60/516,984 entitled DIAPHRAGM ARTICLE WITH FIBER REINFORCEMENT AND METHOD OF MANUFACTURING SAME filed Nov. 3, 2003, in the name of the above named inventors, the disclosure of which is incorporated herein by reference thereto.

### BACKGROUND OF THE INVENTION

1. Field of the Invention

The present invention relates to diaphragm articles and methods of manufacturing such articles, and, more particularly, to the fabrication and material composition of diaphragm structures incorporating fiber reinforcement.

2. Description of the Related Art

Elastomeric diaphragms are widely used in many applications. The resilience of the diaphragms permits them to change in shape in response to, for example, an imbalance in fluid pressures applied to opposite sides of the diaphragm. Diaphragms are typically constrained at its periphery so that differential forces can be applied, causing the diaphragm to be at least locally distended and/or displaced in response to an imbalance in pressures applied to opposite sides of the diaphragm. The diaphragm isolates the pressure applying medium on one side of the diaphragm from the medium on the other side.

A diaphragm may convert a fluid pressure into a mechanical force that can be employed to actuate some other element in response to the diaphragm displacement. Likewise, a mechanical force applied to a diaphragm by a plunger or other mechanical element causes an increase in fluid pressure on an opposite side of the diaphragm. The transferred pressure can be applied in many ways, for example, in a pump in which the diaphragm isolates the mechanical driving element from a pumped fluid.

A diaphragm may have any shape. Although the simplest diaphragm configurations are planar, elastomeric diaphragms are not restricted to such simple shapes. For example, a diaphragm may include a protruding shape for receiving a mechanical plunger or for responding in a non-linear way to a fluid or mechanical force. The walls of a protruding portion of a diaphragm may engage a mechanical plunger so that the configuration of the diaphragm changes as the position of the plunger changes in response to applied forces. A diaphragm engaging a plunger and following its movement through a circumferential fold can be considered to “roll”. The circumferential fold in the diaphragm changes in position with the position of the plunger engaging the diaphragm.

The repeated flexing of a diaphragm in response to changes in pressure can gradually weaken a diaphragm. Moreover, each elastomer used in a diaphragm has an elastic limit and limited strength. The strength of a diaphragm may be changed by altering the thickness of a particular elastomer or by selecting a different elastomer. However, changing thickness may not be permissible in some applications where space is limited and diaphragm thickness is critical. Further, changing elastomer thicknesses or changing elastomers causes changes in elastic characteristics, such as stiffness, that affect the suitability of a diaphragm in a particular application.

One technique for increasing the tensile strength of elastomers, such as rubbers, beyond their inherent tensile strengths is the embedding of a reinforcing fabric within the elastomer. The conventional reinforcing fabrics have woven fibers or threads, usually woven biaxially, i.e., in two orthogonal directions. Fabrics conventionally used for such reinforcements include nylon and polyester.

A reinforcing fabric may be embedded within a planar elastomeric diaphragm or in a non-planar diaphragm. In a planar diaphragm, the reinforcing fabric is distorted only when the diaphragm is distorted by an applied pressure. However, in a non-planar diaphragm, extreme localized compression and other asymmetrical distortions may occur that can decrease the lifetime of the diaphragm and lead to failure, particularly when subjected to repeated compression and frictional cycles.

### SUMMARY OF THE INVENTION

According to the present invention there is provided a diaphragm article including an elastomeric body reinforced with pulp dispersions of fiber. The diaphragm may be fabricated using conventional molding techniques, such as compression molding and transfer molding. The principal reinforcement mechanism is fiber, which replaces or substitutes for the use of fabric.

In one form, a diaphragm article includes an elastomer body reinforced with a pulp dispersion of polyaramid fibers. The elastomer has a material composition consisting of a silicon and/or fluoro-silicon polymer. The elastomer is blended with fiber to produce a heterogenous mixture, according to techniques known to those skilled in the art. A compression molding process is used to fabricate the diaphragm, where a composition of aramid reinforced elastomer is employed as the preform structure.

The diaphragm structure provides an increased strength and stiffness threshold. One diaphragm form includes fibers oriented generally orthogonally to the central pressure axis to provide improved radial stiffness.

The diaphragm construction may be augmented with fabric reinforcement to provide further improvements in durability and performance.

One advantage of the present invention is that cost reductions and economic efficiencies are possible with fiber reinforcement relative to fabric-based reinforcement.

Another advantage of the present invention is that the fiber reinforcement provides increased strength and stiffness that enables more compact and smaller diaphragm structures to be manufactured without compromising performance or durability.

Another advantage of the invention is that the fiber reinforcement results in elevated threshold yield levels due to the attendant improvements in strength and stiffness.

A further advantage of the invention is that the strength and stiffness profiles of diaphragms can be easily scaled by blending elastomers with variable (e.g., higher) levels of fiber content; such scaling is not as readily accomplished in strictly fabric-based reinforcements since larger fabric designs may not be as easily accommodated as compared to the ease of implementing higher fiber dispersions.

A further advantage of the invention is that the diaphragm articles may employ conventional molding processes such as compression molding and transfer molding.

A further advantage of the invention is that the diaphragm construction including a silicon and/or fluoro-silicon polymer reinforced with polyaramid fibers (such as Twaron or other equivalent product) is readily amenable to compression molding due to the viscosity characteristics of the elastomer resin.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front perspective view of a transfer molding apparatus for use in manufacturing a diaphragm article, according to one form of the invention;

FIG. 2 is an upper plan axial view of a diaphragm structure, constructed in accordance with the invention;

FIG. 3 is a front perspective view of a compression molding apparatus for use in manufacturing a diaphragm article, according to another form of the invention; and

FIG. 4 is a perspective view of a diaphragm article constructed according to the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

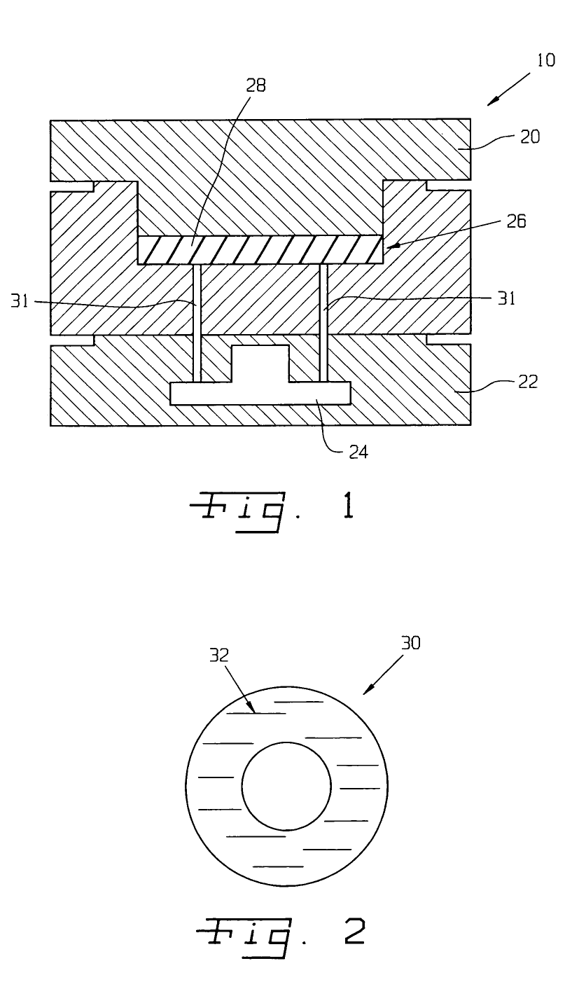

Referring now to the drawings and particularly to FIG. 1, there is shown a transfer molding apparatus 10 for use in manufacturing a diaphragm article, according to one form of the invention.

In brief, according to this form of the invention and as known to those skilled in the art, transfer molding encompasses a molding process used for thermosetting resins. The molding material, which may be preheated, is placed in an open pot at the top of a closed mold. In particular, the mold may be initially removed from the press and opened. A precut “slug” of uncured rubber, at a set weight, is placed into the transfer pot. If a reinforcement insert is to be integrated, the insert is first placed into the cavity. The loaded mold is then placed back into the press and the press is then closed. A plunger is placed in the pot above the material.

Pressure applied by a press platen to the plunger forces the molding material into the gates, runners and cavities of the heated mold. The pressure forcing the plates together distributes (transfers) the precut slug of uncured rubber in the pot down through the sprues and into the cavities. The uncured rubber is then forced into the shape of the cavity in the mold, e.g., diaphragm configuration. A slight excess of material may flow out of the cavity, along the gates and vents. The mold remains closed until the rubber is cured, completing the cycle. For example, following a heating cycle during which the material is cured, the press is opened and the parts are ejected.

Any conventional transfer molding apparatus and fabrication process protocol may be used to practice the invention.

Referring to FIG. 1, the illustrated apparatus 10 has a conventional form and includes an upper plate 20 and a lower plate 22. An exemplary cavity mold 24 is defined in lower plate 22 in the shape of a desired diaphragm structure. A conventional pot (generally indicated at 26) carries a pad of molding material 28 that will be communicated via illustrative sprues 31 into cavity mold 24 where it will be formed into the indicated diaphragm configuration, according to a conventional transfer molding process.

The machine configuration depicted by FIG. 1 should not be considered in limitation of the invention but merely representative of one type of transfer molding assembly, as it should be apparent to one skilled in the art that any other suitable machine environment may be used to facilitate a transfer molding fabrication process.

In brief, during operation, a compressive pressure is applied to molding material 28 as upper plate 20 is urged against bottom plate 22. Pad 28 may be warmed to provide a composition of suitable viscosity to facilitate its flowability, in a manner known to those skilled in the art. In response to the applied pressure, the molding material 28 flows through sprues 31 into cavity mold 24 where it produces a final form of the indicated diaphragm shape.

According to one aspect of the invention, molding material 28 is provided in a compositional form including, but not limited to, an elastomer reinforced with pulp dispersions of fibers, e.g., aramid components.

The host substrate or raw material (i.e., elastomer body) of the invention may be formed of materials including, but not limited to, brand name products such as EP(D)M (VMQ (silicon) and FVMQ (fluoro-silicon)), NBR (nitrile), XNBR (carboxylated nitrile), HNBR (hydrated nitrile), FKN (fluoro-carbon), ECO (epochlorohydron), GECO, CO, and ACM (acrylonitrile). This material listing should not be considered in limitation of the invention but merely illustrative thereof, as it should be apparent to those skilled in the art that other suitable material constituents may be used in forming the diaphragm articles discussed herein.

In other forms, the diaphragm articles constructed according to the invention may be formed from other suitable elastomers, rubbers, plastics, resins, and/or polymers.

The aramid reinforced elastomers of the invention may include reinforcement components including, but not limited to, para-polyaramid fibers, e.g., the brand name products Twaron and Kevlar, which is a product of DuPont de Nemours of Wilmington, Del. and serves as a high-performance para-aramid fiber useful as a reinforcement.

Various advantages accrue from the use of an elastomer with pulp dispersions of fiber reinforcement as the molding material for use in manufacturing a diaphragm according to a transfer molding process. For example, reinforcement of the elastomer with pulp dispersions of fiber avoids the use of an embedded fabric typically employed for reinforcement.

Additionally, the transfer molding process may be suitably controlled in a manner known to those skilled in the art to develop directional or anisotropic properties along desired dimensions. For example, it is advantageous to control the manufacturing process so that the fiber orientation in the final diaphragm structure lies along a dimension providing increased strength and/or stiffness in a particular direction.

For example, referring to FIG. 2, there is shown an upper plan view of a diaphragm structure 30 constructed in accordance with the invention. As shown, diaphragm 30 includes a distribution of individual fibers 32 generally extending in a radial direction between the inner diameter and outer diameter of diaphragm 30. In this manner, improvements are made to the strength and stiffness of diaphragm 30 along the radial direction. As a result, increased resistance is provided to counteract working stresses and strains (e.g., pressure differentials) that may attempt to unduly elongate or stretch diaphragm 30 along the radial dimension.

Furthermore, this selective control of the fiber orientation may be considered as an optimization technique useful to produce a diaphragm having a desired or necessary stiffness or strength measure. Typically, the directionality of the fiber orientation within the elastomer body will be tailored relative to a reference axis. For example, fibers may be oriented to lie generally in certain plane(s) of the elastomer body so as to be arranged orthogonally to the pressure axis or central axis of the diaphragm. The directionality of the fiber reinforcement resists deformation due to pressure differentials or uneven or imbalanced applied forces, for example.

The increased strength and stiffness along the radial direction also enables modifications to be made to the geometry of the diaphragm. For example, due to the elevated radial strength, the diaphragm can be fabricated with a smaller thickness since the fiber reinforcement furnishes the needed stiffness that otherwise may need to be supplied by an axially-thicker diaphragm. Accordingly, it should be understood that the invention may be used to manufacture diaphragm structures having any desired aspect ratio, i.e., ratio of length to diameter of the diaphragm. For example, by adjusting the fiber content level, different strength and stiffness profiles may be achieved that allow corresponding diaphragm structures to be fabricated having different aspect ratios yet similar strength and stiffness behaviors. The diaphragm structures of the invention will therefore possess improved strength-to-aspect ratio measures.

Other directionalized fiber reinforcement patterns may be developed according to the invention. In particular, suitable control of the fiber dispersion and transfer molding process can be used to control the ultimate distribution pattern of fibers in the elastomer body in its final form as a diaphragm.

The improvements in strength and stiffness also increase the failure limit of the diaphragm in terms of maximum allowable load. In particular, the fiber reinforcement produces elevated yield threshold points in the diaphragm, such as torsional, compression, elongation, and tension yields. As a result, the fiber reinforced elastomer can sustain a wider range and variety of operating temperatures, pressures, and fluids.

Another benefit stems from the ability to readily incorporate the reinforcement mechanism (i.e., pulp dispersion of fibers) in diaphragm structures having any aspect ratio. For example, in applications employing strictly fabric reinforcement, there may be difficulties in scaling up to higher aspect ratios (e.g., greater non-planarity and/or increased three-dimensionality) due to the greater complexity in incorporating the fiber structure into the diaphragm mold. However, in the invention, higher aspect ratio designs are easily accommodated by changes to the fiber content during the blending process, in a conventional manner.

Moreover, design attributes such as space, material, and structural savings can be accomplished with the invention since the improvements from the fiber reinforcement enable the same or better strength and stiffness performance to be realized at lower aspect ratio designs.

Referring now to FIG. 3, there is shown a compression molding apparatus 50 for use in manufacturing a diaphragm article, according to another form of the invention.

In brief, according to this form of the invention and as known to those skilled in the art, compression molding encompasses a technique for molding thermoset plastics in which a part is shaped by placing the fiber and resin into an open mold cavity, closing the mold, and applying heat and pressure until the material has cured or achieved its final form. As used herein, but without limitation, thermoset may be considered to refer to a class of plastics that, when cured using heat, chemical or other means, changes into a substantially infusible and insoluble material.

In particular, compression molding conventionally involves a method of molding in which the molding material, generally preheated, is first placed in an open, heated mold cavity. The mold is closed with a top force or plug member, pressure is applied to force the material into contact with all mold areas, and heat and pressure are maintained until the molding material has cured. The process employs thermosetting resins in a partially cured stage, such as in the form of granules, putty-like masses, or preforms.

Prior to production, the mold is removed from the press and opened. A precut or shaped “slug” or preform of uncured rubber, at a set weight, is placed into the cavity. If fabric reinforcement is desired, the fabric insert is also placed into the cavity at this time. The loaded mold is then placed back into the press and the press is then closed. The pressure forcing the plates together forces the uncured rubber to flow into the shape of the cavity in the mold. A slight excess of material may flow out of the cavity along the gates and vents allowing the mold to close. The mold remains closed until the rubber is cured completing the cycle.

Any conventional compression molding apparatus and fabrication process protocol may be used to practice the invention.

Referring to FIG. 3, the illustrated apparatus 50 includes an upper plate 52 and a lower plate 54. Plate 54 defines a mold cavity or tooling (generally indicated at 56) in the shape of a desired diaphragm configuration. As shown, mold cavity 56 contains molding material 60 conforming to the shape of the diaphragm configuration, according to the working principles of compression molding. In particular, for example, a preformed rubber slug is provided that is compression molded into mold cavity 56 to produce the illustrated diaphragm article or part 60.

The machine configuration depicted by FIG. 3 should not be considered in limitation of the invention but merely representative of one type of compression molding assembly, as it should be apparent to one skilled in the art that any other suitable machine environment may be used to facilitate a compression molding fabrication process.

In all other respects, the features of compression molding according to FIG. 3 employ the same considerations applicable to the transfer molding process described in relation to FIGS. 1 and 2, for example, the composition of the molding material (i.e., fiber reinforcement of an elastomer body via a pulp fiber dispersion), the attendant advantages, and various process considerations (e.g., fiber orientation). Accordingly, the features and considerations pertaining to transfer molding are equally applicable to compression molding.

In one preferred form of the invention, a diaphragm is constructed by a compression molding process using a preform comprising a low-viscosity elastomeric polymer such as silicon or fluoro-silicon (or other comparable material) reinforced with a polyaramid fiber such as Twaron (or other comparable fiber material) (available from *).

Regarding further features of the invention, the fiber-reinforced elastomers of the invention may have a fiber content (e.g., amount of fiber present in a composite expressed either as a percent by weight or percent by volume; also sometimes stated as a fiber volume fraction) that can be selectively chosen according to blending techniques well known to those skilled in the art.

The diaphragms constructed according to the invention preferably exhibit anisotropic properties, i.e., exhibiting different properties when tested along axes in different directions within the material. For example, in one form, it is advantageous to fabricate the diaphragms to exhibit increased strength and stiffness in the radial direction, such as in the region extending between the inner diameter and outer diameter of a diaphragm having a washer-type cross-section.

Various conventional manufacturing techniques may be used to produce the aramid reinforced elastomers of the invention. For example, as discussed previously, compression molding may be used, employing single or multiple daylight presses to mold elastomers through a single pressure axis into single or multiple cavities.

Alternately, transfer molding may be used, employing an injection pot in which a pad of material (i.e., fiber reinforced elastomer) is warmed and forced by a plunger through injection ports into a compression mold. Additionally, an assembly of calendered panels may be used in the manufacturing process. In particular, calendering produces an elastomer-fabric sandwich useful for subsequent compression molding.

The diaphragms constructed according to the invention may be supplemented with fabric reinforcement. Such fabric reinforcement may be implemented using any conventional technique known to those skilled in the art. Any type of fabric material, composition, and structure can be used.

The fiber reinforcement of the invention is capable of producing an increase in stiffness at extremely low elongations to improve the pressure resistance of fabric and non-fabric reinforced diaphragms.

The diaphragm articles produced according to the invention may include any type of diaphragm configuration. For example, planar and non-planar diaphragms may be formed. Additionally, various diaphragm styles may be used, such as convoluted, double convoluted, double-sided, beaded, fabric reinforced, and other variations and combinations of these design features. Barrier coated diaphragms may also be constructed.

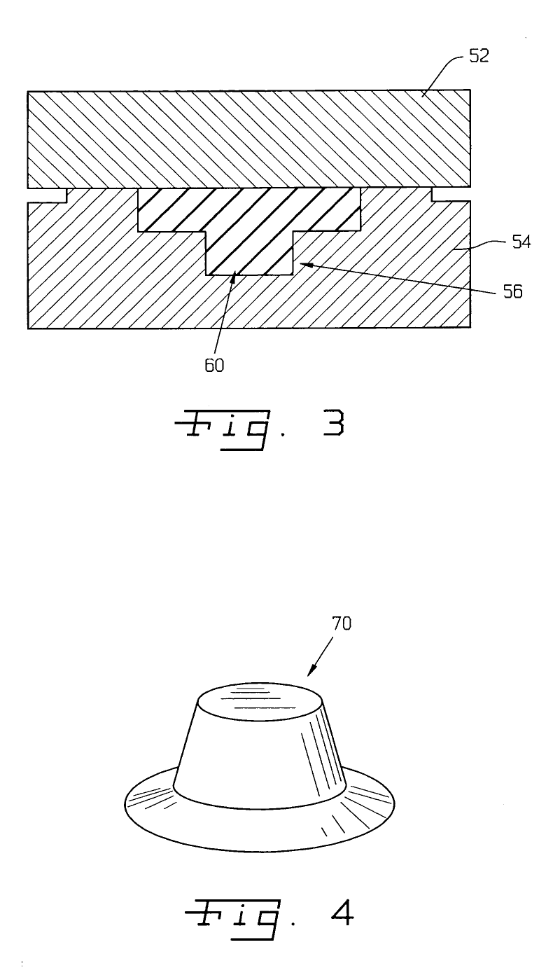

FIG. 4 shows a lateral perspective view of one exemplary configuration of a diaphragm 70 that may be produced according to the invention. In one descriptive form, diaphragm 70 may be considered to possess a “pilgrim” hat shape. However, this illustration should not be considered in limitation of the invention but merely illustrative thereof, as is should be apparent that any other diaphragm shape or configuration may be constructed according to the invention.

The diaphragm articles may be constructed across a wide range of aspect ratios. For example, depending upon the application, high or low aspect ratio diaphragms may be formed. For example, a high aspect ratio diaphragm may be considered to include a non-planar diaphragm having a permanent projection, such as a conical part extending outwardly from a flange or other mounting part so that, when not stressed by applied pressure, the diaphragm does not lie in a single plane. Additionally, diaphragm articles having intermediate aspect ratio measures may also be manufactured according to the invention.

As used herein, but without limitation, tooling encompasses the mold, either one- or two-sided and either open or closed, in or upon which composite material is placed in order to make a part.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of making an elastomeric diaphragm, comprising the steps of:
providing a mixture of an elastomer containing dispersed fibers;
providing a mold cavity in the form of a diaphragm; and
compression molding the mixture into the mold cavity.

2. The method as recited in claim 1, wherein the mixture comprising an elastomer reinforced with aramid fibers.

3. The method as recited in claim 1, wherein the elastomer having a material composition comprising one of silicon and fluoro-silicon, and the fibers including Twaron.

4. The method as recited in claim 1, wherein at least a portion of the fibers in the compression molded mixture being oriented in a direction generally orthogonal to a central axis of symmetry of the diaphragm form.

5. An article of manufacture in the form of a diaphragm, comprising:
an elastomeric body with reinforcing fibers dispersed throughout the elastomeric body;
the elastomeric body having a material composition comprising one of silicon and fluoro-silicon.

6. The article as recited in claim 5, wherein the fibers including Twaron.

7. The article as recited in claim 5, wherein at least a portion of the fibers being oriented to lie within planes generally orthogonal to a central axis of symmetry of the diaphragm.

8. A method of making an elastomeric diaphragm, comprising the steps of:
providing a mixture of an elastomer containing dispersed fibers;
providing a mold cavity in the form of a diaphragm; and
transfer molding the mixture into the mold cavity.

9. The method as recited in claim 8, wherein the mixture comprising an elastomer reinforced with aramid fibers.

10. The method as recited in claim 8, wherein the elastomer having a material composition comprising one of silicon and fluoro-silicon, and the fibers including Twaron.

11. The method as recited in claim 8, wherein at least a portion of the fibers in the transfer molded mixture being oriented in a direction generally orthogonal to a central axis of symmetry of the diaphragm form.
